(19) United States
(12) Patent Application Publication
(10) Pub. No.: US 2023/0150811 A1
(43) Pub. Date: May 18, 2023

(54) AUTOMATIC IDENTIFICATION HYDROGEN REFUELING SYSTEM AND METHOD

(71) Applicant: NORTH UNIVERSITY OF CHINA, Taiyuan City (CN)

(72) Inventors: Qiang LI, Taiyuan City (CN); Jiabo ZHANG, Taiyuan City (CN); Zhiqun SUN, Taiyuan City (CN); Pengjun ZHANG, Taiyuan City (CN); Xiaoming HAN, Taiyuan City (CN); Pu QU, Taiyuan City (CN)

(21) Appl. No.: 17/863,916

(22) Filed: Jul. 13, 2022

(30) Foreign Application Priority Data
Nov. 18, 2021 (CN) 202111365910.6

(51) Int. Cl. B67D 7/04; B67D 7/32

(52) U.S. Cl. CPC B67D 7/0401; B67D 7/3209; B67D 2007/0446; B67D 2007/0474

(57) ABSTRACT

The automatic identification hydrogen refueling system includes a ground positioning module, a hydrogen storage module, a mechanical arm, a refueling module, an automatic identification module and an information processing module. The ground positioning module is provided with a sensor. A hydrogen conveying pipeline is connected with the refueling module. The hydrogen storage module is arranged at a tail end of the ground positioning module, and connected with the mechanical arm, the information processing module and the hydrogen conveying pipeline. The information processing module controls the mechanical arm to drive the refueling module to preliminarily align a refueling connector after receiving a sensor signal. The automatic identification module identifies an accurate position of the refueling connector, the information processing module drives the mechanical arm to move until butting of the hydrogen refueling gun head and the refueling connector is completed, monitors and controls the refueling amount and the refueling pressure.

### CROSS REFERENCE TO RELATED APPLICATION

This application claims priority to Chinese Patent Application No. 202111365910.6 filed on Nov. 18, 2021, which is hereby incorporated by reference in its entirety.

### TECHNICAL FIELD

The present disclosure belongs to the technical field of hydrogen refueling, and specifically relates to an automatic identification hydrogen refueling system and an automatic identification hydrogen refueling method.

### BACKGROUND ART

With the enhancement of global environmental protection consciousness and the rapid development of fuel cells, civil hydrogen fuel automobiles are used in a large amount. The refueling demand of hydrogen fuel is increased suddenly, and the number of hydrogen refueling stations is increased with days. For the existing hydrogen refueling system, the refueling process is completed mainly through manual operation; the hydrogen refueling process is slow, and the safety requirement on manual operation is high. Therefore, automatic transformation of the refueling system is of great significance for improving the refueling efficiency, the safety coefficient and the service life of the refueling system.

### SUMMARY

The present disclosure aims to solve the problem that existing manual hydrogen refueling is slow and the safety requirement on the manual operation is high, and provides an automatic identification hydrogen refueling system.

The present disclosure provides an automatic identification hydrogen refueling system, including a ground positioning module, a hydrogen storage module, a mechanical arm, a refueling module, an automatic identification module and an information processing module.

The ground positioning module is provided with a sensor. A hydrogen conveying pipeline is connected to the refueling module. The hydrogen storage module is arranged at a tail end of the ground positioning module, and the hydrogen storage module is connected with the mechanical arm, the information processing module and the hydrogen conveying pipeline. A free end of the mechanical arm is connected with the refueling module. The mechanical arm drives the refueling module to move and reset, and the refueling module is provided with a hydrogen refueling gun head and an automatic identification module. The hydrogen conveying pipeline is connected with the refueling module.

The information processing module is electrically connected with a sensor of the ground positioning module, the refueling module and the automatic identification module. The information processing module controls the mechanical arm to drive the refueling module to preliminarily align with a refueling connector on a fuel automobile after receiving a signal of the sensor. The automatic identification module identifies an accurate position of the refueling connector and transmits an accurate position signal to the information processing module, the information processing module drives the mechanical arm to drive the hydrogen refueling gun head to move until butting of the hydrogen refueling gun head and the refueling connector is completed, and the information processing module monitors and controls a refueling amount and a pressure of the refueling module.

Further, the refueling module is provided with an alarm device, and the alarm device is electrically connected with the information processing module and used for monitoring a fuel leakage condition during a refueling process in real time and automatically giving an alarm when fuel leaks during the refueling process.

Further, the alarm device comprises an information acquisition card, an information processing terminal and a state information display.

A gas detector and a pressure sensor for detecting hydrogen concentration and pressure in real time during the refueling process are provided within the refueling module. A detection result is converted into a digital signal through the information acquisition card to be transmitted to the information processing terminal. The information processing terminal compares the digital signal received, with predetermined gas concentration values and predetermined pressure values at different grades, and outputs a corresponding state signal to a state information display, and the state display displays a refueling safety state according to the corresponding state signal.

Further, the information processing terminal of the alarm device has three signal grades which are respectively a safety signal, a warning signal and a danger signal; the state display has three display states correspondingly which are respectively green, orange and yellow.

When the state signal received by the information processing terminal is the warning signal or the danger signal, the information processing terminal transmits the state signal to the information processing module, the information processing module correspondingly sends out a warning alarm or a danger alarm, and the information processing module controls the refueling module to immediately stop hydrogen refueling while the danger alarm is sent out.

Further, the automatic identification module includes a binocular identification camera which is fixed at a bottom of the refueling module and electrically connected with the information processing module.

Further, the information processing module is provided with a control panel which is used for receiving and storing hydrogen refueling information.

Further, the hydrogen refueling gun head is matched with the refueling connector of the fuel automobile.

It is also provided an automation identification hydrogen refueling method. The method includes, transmitting a signal to the information processing module by the sensor when the fuel automobile drives to a position corresponding to the sensor of the ground positioning module, after the fuel automobile drives into a refueling area; controlling the mechanical arm, through the information processing module, to drive the refueling module to preliminarily find the hydrogen refueling connector after the fuel automobile stops moving, then driving the mechanical arm through the information processing module to move according to a signal fed back by the binocular identification camera until automatic alignment between the hydrogen refueling gun head and the hydrogen refueling connector is completed, and performing butting and locking of the hydrogen refueling gun head and the hydrogen refueling connector; after butting, releasing a hydrogen refueling signal by the information processing module to the hydrogen storage module according to received hydrogen refueling information, and performing refueling; after refueling, releasing a refueling completion signal by the information processing module to the hydrogen storage module, and stopping hydrogen supply from the hydrogen storage module, wherein the refueling module conducts safe pressure relief, the hydrogen refueling gun head is separated from the hydrogen refueling connector, and all modules reset and the automobile is driven away.

Compared with the prior art, the present disclosure has the following beneficial effects.

After the fuel automobile is identified, the position of the refueling connector is searched preliminarily, then the refueling connector is accurately found and butting of the refueling connector is completed. The present disclosure can meet hydrogen refueling requirement of the automobile with different appearance dimensions and different hydrogen refueling port positions, control the refueling amount and the pressure, and automatically complete hydrogen fuel refueling in the whole process, thereby reducing manual operation during the refueling process and improving the refueling efficiency.

Furthermore, in the refueling process, the alarm device monitors the fuel leakage condition in real time, automatically gives an alarm when the fuel leaks and immediately closes the hydrogen refueling gun, gas is prevented from continuously leaking, thereby improving the safety coefficient and the service life of the refueling system.

### BRIEF DESCRIPTION OF THE DRAWINGS

FIG. 1 is a schematic structural diagram of a hydrogen refueling system according to the present disclosure;

FIG. 2 is a schematic diagram showing connection between a refueling module and an automatic identification module;

FIG. 3 is a schematic structural diagram of a refueling connector of a fuel automobile;

FIG. 4 is a flow diagram of real-time monitoring and automatic alarm of the refueling module; and

FIG. 5 is a flow diagram of a hydrogen refueling method.

Reference numerals: 1 fuel automobile; 2 hydrogen storage module; 3 information processing module; 4 mechanical arm; 5 refueling module; 6 automatic identification module; 7 ground positioning module; 8 hydrogen refueling gun head; 9 binocular identification camera; 10 hydrogen conveying pipeline; and 11 refueling connector.

### DETAILED DESCRIPTION OF THE EMBODIMENTS

Embodiments of the present disclosure are described by the following specific examples. Those skilled in the art can easily understand other advantages and effects of the present disclosure from the content disclosed by the description.

The structures, proportions, sizes and the like depicted in the specification are only used for describing the contents disclosed in the specification for people familiar with the technology to understand and read, and are not used for limiting the implementation conditions of the present disclosure, so that the structures, proportions, sizes and the like depicted in the specification do have substantial technical meanings; modification of any structure, change of proportional relation or adjustment of the size should be fallen within the scope of what the technical content disclosed herein can cover, without affecting the effects and achievable objectives of the present disclosure. The terms such as “upper”, “lower”, “left”, “right”, “middle” and “a (an)”, which are used in this specification, are also used for ease of description only and are not used to limit the scope of the present disclosure, and changes or adjustments in the relative relationships are considered to be within the scope of the present disclosure without substantial changes in the technical content.

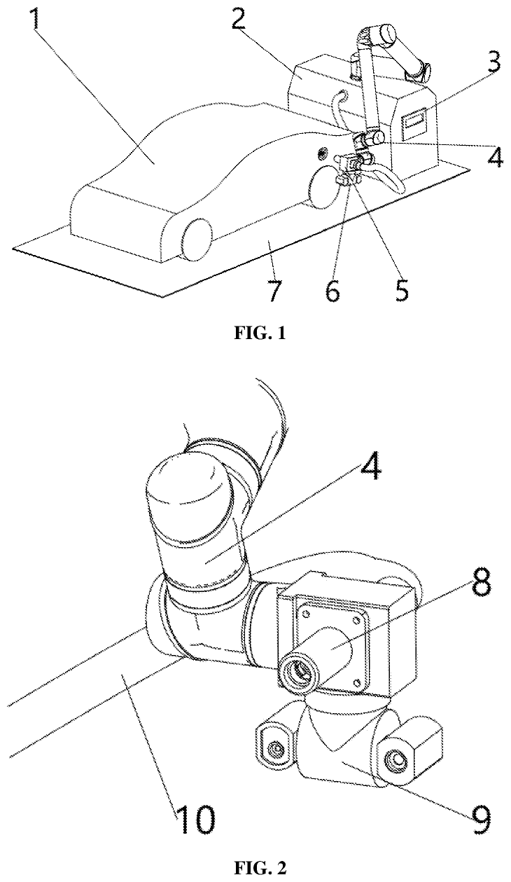

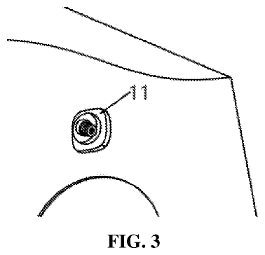

Referring to FIG. 1 to FIG. 3, the present disclosure provides an automatic identification hydrogen refueling system, which includes a ground positioning module 7, a hydrogen storage module 2, a mechanical arm 4, a refueling module 5, an automatic identification module 6 and an information processing module 3.

The ground positioning module 7 is provided with a sensor, a hydrogen conveying pipeline 10 is connected with the refueling module 5, the hydrogen storage module 2 is arranged at a tail end of the ground positioning module 7. The hydrogen storage module 2 is connected with the mechanical arm 4, the information processing module 3 and the hydrogen conveying pipeline. A free end of the mechanical arm 4 is connected with the refueling module 5, the mechanical arm 4 drives the refueling module 5 to move and reset, the refueling module 5 is provided with a hydrogen refueling gun head 8 and an automatic identification module 6, and the hydrogen conveying pipeline 10 is connected with the refueling module 5.

The information processing module 3 is electrically connected with the sensor of the ground positioning module 7, the refueling module 5 and the automatic identification module 6. The information processing module 3 controls the mechanical arm 4 to drive the refueling module 5 to preliminarily align with a refueling connector 11 on a fuel automobile 1 after receiving a signal of the sensor, the automatic identification module 6 identifies the accurate position of the refueling connector 11 and transmits the signal of the accurate position to the information processing module 3, the information processing module 3 drives the mechanical arm 4 to drive the hydrogen refueling gun head 8 to move until butting of the hydrogen refueling gun head 8 and the refueling connector 11 is completed, and the information processing module 3 monitors and controls the refueling amount and the pressure of the refueling module 5.

The refueling module 5 is provided with an alarm device, and the alarm device is electrically connected with the information processing module 3 and used for monitoring the fuel leakage condition in the refueling process in real time and automatically giving an alarm when fuel leaks in the refueling process.

The alarm device includes an information acquisition card, a signal processing terminal and a state information display.

The refueling module 5 is internally provided with a gas detector and a pressure sensor for detecting hydrogen concentration and pressure in the refueling process in real time. The detection result is converted into a digital signal through the information acquisition card to be transmitted to the information processing terminal, the information processing terminal compares the received digital signal with the predetermined gas concentration values and the predetermined pressure values at different grades, a corresponding state signal is output to a state information display, and the state display displays the refueling safety state according to the corresponding state signal.

The information processing terminal of the alarm device has three signal grades which are respectively a safety signal, a warning signal and a danger signal; the corresponding state display has three display states which are respectively green, orange and yellow.

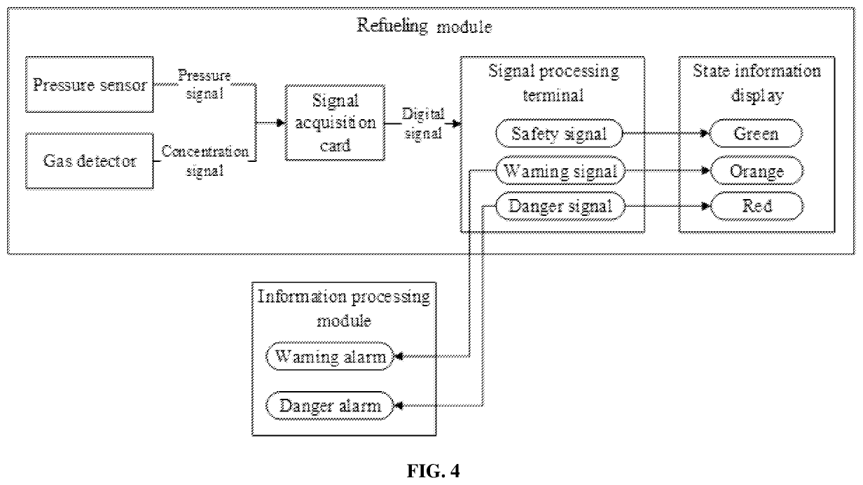

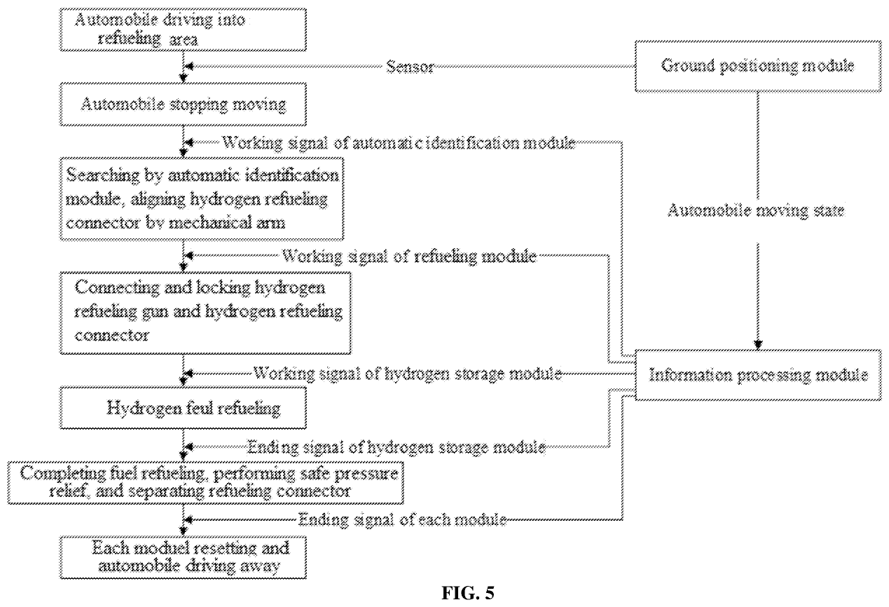

As shown in FIG. 4, when the signal received by the information processing terminal is the warning signal or the danger signal, the information processing terminal transmits the signal to the information processing module 3, the information processing module 3 correspondingly sends out a warning alarm or a danger alarm, and the information processing module 3 controls the refueling module 5 to immediately stop hydrogen refueling while the danger alarm is sent out. The warning alarm and the danger alarm are distinguished by different alarm sounds. If the numerical value is within a safety range, the information processing terminal outputs a safety signal, the safety signal is received by the state information display, and the display displays a safety state (green) in a color form. If the numerical value exceeds a safety range but does not reach a dangerous range, namely, the numerical value is in a warning range, and at the moment, a small amount of hydrogen leaks near the whole refueling area but is not enough to cause safety accidents such as combustion and explosion, the information processing terminal outputs the warning signal to the information processing module 3 and the state information display at the same time; the information processing module 3 sends out the warning alarm, and meanwhile, the state information display displays a warning state (orange). If the numerical value exceeds the warning range, namely, the numeral value is in the dangerous range, at the moment, serious safety accidents such as detonation and explosion may happen to the whole refueling area at any time; the information processing terminal outputs the danger signal to the information processing module 3, the refueling module 5 and the state information display at the same time; the information processing module 3 sends out the danger alarm; the refueling module 5 immediately closes a valve of a hydrogen refueling gun, namely blocks a gas channel to prevent gas from leaking, and meanwhile, the state information display displays a danger state (red).

The automatic identification module 6 includes a binocular identification camera 9, the binocular identification camera 9 is fixed at a bottom of the refueling module 5, and the binocular identification camera 9 is electrically connected with the information processing module 3.

The information processing module 3 is provided with a control panel, and the control panel is used for receiving and storing hydrogen refueling information.

The hydrogen refueling gun head 8 is matched with the refueling connector 11 of the fuel automobile 1.

The refueling connector 11 is arranged on a side face of the fuel automobile 1. The pressure sensor is arranged in an area where wheels are located when the fuel automobile 1 is parked. The hydrogen storage module 2 stores and releases hydrogen fuel and is arranged behind the fuel automobile 1. The information processing module 3 is used for processing the positioning information of the ground positioning module 7, the identification information of the automatic identification module 6 and the movement information of the mechanical arm 4; the information processing module 3 is used for processing information exchange of the whole hydrogen refueling system; and the refueling module 5 can control unlocking and locking of the hydrogen refueling gun head 8.

The present disclosure also provides an automatic identification hydrogen refueling method. When the fuel automobile 1 conducts hydrogen fuel refueling, firstly, the fuel automobile 1 drives into the refueling area. When the fuel automobile 1 is close to the hydrogen storage module 2, the sensor of the ground positioning module 7 identifies moving condition of the fuel automobile 1 and transmits an identification signal to the information processing module 3.

After the fuel automobile 1 stops moving, the information processing module 3 releases a hydrogen refueling butting signal to the refueling module 5. The refueling module 5 starts hydrogen refueling operation. Firstly, the automatic identification module 6 fixed to an arm end of the mechanical arm 4 starts to operate. Under traction of the mechanical arm 4, the binocular identification camera 9 starts to move around the automobile body, and detects the hydrogen refueling connector 11 of the fuel automobile 1 during the moving process. After the hydrogen refueling connector 11 of the fuel automobile 1 is successfully identified, the hydrogen refueling gun head 8 and the hydrogen refueling connector 11 are automatically aligned under the traction of the mechanical arm 4.

The information processing module 3 releases a connecting signal, and butting and locking of the hydrogen refueling gun head 8 and the hydrogen refueling connector 11 are completed under the action of the refueling module 5.

After receiving a butting completion signal, the information processing module 3 releases a hydrogen refueling signal, the hydrogen storage module 2 starts to release hydrogen fuel after receiving the hydrogen refueling signal, and the fuel flows through the hydrogen conveying pipeline 10 and the hydrogen refueling gun head 8 and enters a fuel container in the fuel automobile 1.

When hydrogen fuel refueling is completed, the information processing module 3 releases a refueling completion signal, the hydrogen storage module 2 stops hydrogen supply, and the refueling module 5 conducts safe pressure relief. After the pressure is reduced to a safe range, the hydrogen refueling gun head 8 and the hydrogen refueling connector 11 are unlocked under the action of the refueling module 5, and the hydrogen refueling gun head 8 is pulled out through the mechanical arm 4. The mechanical arm 4 and the refueling module 5 are reset to an initial state, and the initial state is that the mechanical arm 4 and the refueling module 5 are located above the hydrogen storage module 2. At the moment, the information processing module 3 releases a departure signal. The ground positioning module 7 sends out a signal after the fuel automobile 1 is departed. The information processing module 3 checks and confirms the reset state of each module, and the refueling process is ended.

The above embodiments only exemplarily illustrate the principles and effects of the present disclosure and are not intended to limit the present disclosure. Those skilled in the art may modify or change the above embodiments without departing from the spirit and scope of the present disclosure. Therefore, all equivalent modifications or variations made by those having ordinary skill in the art without departing from the spirit and technical ideas of the present disclosure should still be covered by claims of the present disclosure.

What is claimed is:

1. An automatic identification hydrogen refueling system, comprising a ground positioning module, a hydrogen storage module, a mechanical arm, a refueling module, an automatic identification module and an information processing module, wherein
the ground positioning module is provided with a sensor, a hydrogen conveying pipeline is connected with the refueling module, the hydrogen storage module is arranged at a tail end of the ground positioning module, the hydrogen storage module is connected with the mechanical arm, the information processing module and the hydrogen conveying pipeline, a free end of the mechanical arm is connected with the refueling module, the mechanical arm drives the refueling module to move and reset, the refueling module is provided with a hydrogen refueling gun head and an automatic identification module, and the hydrogen conveying pipeline is connected with the refueling module; and
the information processing module is electrically connected with a sensor of the ground positioning module, the refueling module and the automatic identification module, the information processing module controls the mechanical arm to drive the refueling module to preliminarily align with a refueling connector on a fuel automobile after receiving a signal of the sensor, the automatic identification module identifies an accurate position of the refueling connector and transmits an accurate position signal to the information processing module, the information processing module drives the mechanical arm to drive the hydrogen refueling gun head to move until butting of the hydrogen refueling gun head and the refueling connector is completed, and the information processing module monitors and controls a refueling amount and a pressure of the refueling module.

2. The automatic identification hydrogen refueling system according to claim 1, wherein the refueling module is provided with an alarm device, and the alarm device is electrically connected with the information processing module and used for monitoring a fuel leakage condition during a refueling process in real time and automatically giving an alarm when fuel leaks during the refueling process.

3. The automatic identification hydrogen refueling system according to claim 2, wherein the alarm device comprises an information acquisition card, an information processing terminal and a state information display; and
a gas detector and a pressure sensor are provided within the refueling module for detecting hydrogen concentration and pressure in real time during the refueling process, a detection result is converted into a digital signal through the information acquisition card to be transmitted to the information processing terminal; the information processing terminal compares the digital signal received, with predetermined gas concentration values and predetermined pressure values at different grades, and outputs a corresponding state signal to a state information display, and the state display displays a refueling safety state according to the corresponding state signal.

4. The automatic identification hydrogen refueling system according to claim 3, wherein the information processing terminal of the alarm device has three signal grades which are respectively a safety signal, a warning signal and a danger signal; the state display has three display states correspondingly which are respectively green, orange and yellow; and
when the state signal received by the information processing terminal is the warning signal or the danger signal, the information processing terminal transmits the state signal to the information processing module, the information processing module correspondingly sends out a warning alarm or a danger alarm, and the information processing module controls the refueling module to immediately stop hydrogen refueling while the danger alarm is sent out.

5. The automatic identification hydrogen refueling system according to claim 4, wherein the automatic identification module comprises a binocular identification camera which is fixed at a bottom of the refueling module and electrically connected with the information processing module.

6. The automatic identification hydrogen refueling system according to claim 5, wherein the information processing module is provided with a control panel which is used for receiving and storing hydrogen refueling information.

7. The automatic identification hydrogen refueling system according to claim 6, wherein the hydrogen refueling gun head is matched with the refueling connector of the fuel automobile.

8. A hydrogen refueling method with the automatic identification hydrogen refueling system according to claim 1, wherein transmitting a signal to the information processing module by the sensor when the fuel automobile drives to a position corresponding to the sensor of the ground positioning module, after the fuel automobile drives into a refueling area; controlling the mechanical arm, through the information processing module, to drive the refueling module to preliminarily find the hydrogen refueling connector after the fuel automobile stops moving, then driving the mechanical arm by the information processing module to move according to a signal fed back by the binocular identification camera until automatic alignment between the hydrogen refueling gun head and the hydrogen refueling connector is completed, and performing butting and locking of the hydrogen refueling gun head and the hydrogen refueling connector; after butting, releasing a hydrogen refueling signal by the information processing module to the hydrogen storage module according to a received hydrogen refueling signal, and performing refueling; after refueling, releasing a refueling completion signal by the information processing module to the hydrogen storage module, stopping hydrogen supply from the hydrogen storage module, wherein the refueling module conducts safe pressure relief, the hydrogen refueling gun head is separated from the hydrogen refueling connector, and all modules reset and the automobile is driven away.
